(19) United States
(12) Patent Application Publication
(10) Pub. No.: US 2017/0205649 A1
(43) Pub. Date: Jul. 20, 2017

(54) POLYHYDROXY COMPOSITIONS FOR SEALING ELECTROPHORETIC DISPLAYS

(71) Applicant: E INK CALIFORNIA, LLC, Fremont, CA (US)

(72) Inventors: Ming WANG, Fremont, CA (US); Yu LI, Fremont, CA (US); Lin SHAO, Fremont, CA (US); Vladimir SOFIYEV, Oakland, CA (US)

(21) Appl. No.: 15/403,742

(22) Filed: Jan. 11, 2017

Related U.S. Application Data
(60) Provisional application No. 62/279,823, filed on Jan. 17, 2016.

(51) Int. Cl. G02F 1/1339; G02F 1/167; C09D 7/12

(52) U.S. Cl. CPC G02F 1/1339; C09D 7/1233; G02F 1/167; G02F 2001/1676; G02F 2001/1672

(57) ABSTRACT

Polyhydroxy sealing formulations for the production of electrophoretic displays, and portions thereof, for example, front plane laminates. When the disclosed polyhydroxy compounds are included in a sealing layer (or in a binder layer), the layer has improved wetting properties, allowing for more consistent application of the layer in a roll-to-roll production process. Additionally, the polyhydroxy compounds can migrate into the electrophoretic medium, where they improve the contrast ratio and reduce ghosting.

### RELATED APPLICATIONS

This application claims priority to U.S. provisional application No. 62/279,823, filed Jan. 17, 2016, which is incorporated herein by reference in its entirety.

### BACKGROUND OF INVENTION

This invention relates to sealing formulations for use in the production of electrophoretic displays, and portions thereof, for example, front plane laminates. When the disclosed polyhydroxy surfactants are included in a sealing formulation that is used in a sealing layer or a binder layer, the layer has improved wetting properties. The improved wetting properties allowing for more consistent application of a sealing layer or a layer of encapsulated electrophoretic media.

Particle-based electrophoretic displays have been the subject of intense research and development for a number of years. In such displays, a plurality of charged particles (sometimes referred to as pigment particles) move through a fluid under the influence of an electric field. The electric field is typically provided by a conductive film or a transistor, such as a field-effect transistor. Electrophoretic displays have good brightness and contrast, wide viewing angles, state bistability, and low power consumption when compared with liquid crystal displays. Such electrophoretic displays have slower switching speeds than LCD displays, however, and electrophoretic displays are typically too slow to display real-time video. Additionally, the electrophoretic displays can be sluggish at low temperatures because the viscosity of the fluid limits the movement of the electrophoretic particles. Despite these shortcomings, electrophoretic displays can be found in everyday products such as electronic books (e-readers), mobile phones and mobile phone covers, smart cards, signs, watches, shelf labels, and flash drives.

An electrophoretic image display (EPID) An EPID typically comprises a pair of spaced-apart plate-like electrodes. At least one of the electrode plates, typically on the viewing side, is transparent. An electrophoretic fluid composed of a dielectric solvent with charged pigment particles dispersed therein is enclosed between the two electrode plates. An electrophoretic fluid may have one type of charged pigment particles dispersed in a solvent or solvent mixture of a contrasting color. In this case, when a voltage difference is imposed between the two electrode plates, the pigment particles migrate by attraction to the plate of polarity opposite that of the pigment particles. Thus, the color showing at the transparent plate can be either the color of the solvent or the color of the pigment particles. Reversal of plate polarity will cause the particles to migrate to the opposite plate, thereby reversing the color. Alternatively, an electrophoretic fluid may have two types of pigment particles of contrasting colors and carrying opposite charges and the two types of pigment particles are dispersed in a clear solvent or solvent mixture. In this case, when a voltage difference is imposed between the two electrode plates, the two types of pigment particles would move to opposite ends (top or bottom) in a display cell. Thus, one of the colors of the two types of the pigment particles would be seen at the viewing side of the display cell.

Many commercial electrophoretic media essentially display only two colors, with a gradient between the black and white extremes, known as “grayscale.” Such electrophoretic media either use a single type of electrophoretic particle having a first color in a colored fluid having a second, different color (in which case, the first color is displayed when the particles lie adjacent the viewing surface of the display and the second color is displayed when the particles are spaced from the viewing surface), or first and second types of electrophoretic particles having differing first and second colors in an uncolored fluid. In the latter case, the first color is displayed when the first type of particles lie adjacent the viewing surface of the display and the second color is displayed when the second type of particles lie adjacent the viewing surface). Typically the two colors are black and white.

If a full color display is desired, a color filter array may be deposited over the viewing surface of the monochrome (black and white) display. Displays with color filter arrays rely on area sharing and color blending to create color stimuli. The available display area is shared between three or four primary colors such as red/green/blue (RGB) or red/green/blue/white (RGBW), and the filters can be arranged in one-dimensional (stripe) or two-dimensional (2×2) repeat patterns. Other choices of primary colors or more than three primaries are also known in the art. The three (in the case of RGB displays) or four (in the case of RGBW displays) sub-pixels are chosen small enough so that at the intended viewing distance they visually blend together to a single pixel with a uniform color stimulus (‘color blending’). The inherent disadvantage of area sharing is that the colorants are always present, and colors can only be modulated by switching the corresponding pixels of the underlying monochrome display to white or black (switching the corresponding primary colors on or off). For example, in an ideal RGBW display, each of the red, green, blue and white primaries occupy one fourth of the display area (one sub-pixel out of four), with the white sub-pixel being as bright as the underlying monochrome display white, and each of the colored sub-pixels being no lighter than one third of the monochrome display white. The brightness of the white color shown by the display as a whole cannot be more than one half of the brightness of the white sub-pixel (white areas of the display are produced by displaying the one white sub-pixel out of each four, plus each colored sub-pixel in its colored form being equivalent to one third of a white sub-pixel, so the three colored sub-pixels combined contribute no more than the one white sub-pixel). The brightness and saturation of colors is lowered by area-sharing with color pixels switched to black. Area sharing is especially problematic when mixing yellow because it is lighter than any other color of equal brightness, and saturated yellow is almost as bright as white. Switching the blue pixels (one fourth of the display area) to black makes the yellow too dark.

Although seemingly simple, electrophoretic media and electrophoretic devices display complex behaviors. For instance, it has been discovered that simple “on/off” voltage pulses are insufficient to achieve high-quality text in electronic readers. Rather, complicated “waveforms” are needed to drive the particles between states and to assure that the new displayed text does not retain a memory of the previous text, i.e., a “ghost.” See, for example, U.S. Patent Application No. 20150213765. Compounded with the complexities of the electric fields, the internal phase, i.e., the mixture of particles (pigment) and fluid, can exhibit unexpected behavior due to interactions between charged species and the surrounding environment (such as an encapsulation medium) upon the application of an electric field. Additionally, unexpected behaviors may result from impurities in the fluid, pigments, or encapsulation medium. Accordingly, it is difficult to predict how an electrophoretic display will respond to variations in the internal phase composition.

### SUMMARY OF INVENTION

The invention relates to improved sealing compositions for use in fabricating electrophoretic displays. Typically, an electrophoretic display includes at least a light-transmissive electrode, an electrophoretic medium including charged particles, and a sealing layer. The sealing layer includes a sealing composition, which includes a polyhydroxy surfactant. The sealing composition optionally includes conductive fillers, such as carbon black, graphite, graphene, metal filaments, metal particles, or carbon nanotubes. The polyhydroxy surfactant is also dispersible in the electrophoretic medium, to encourage migration of at least a portion of the surfactant from the sealing layer to the electrophoretic medium. In some instances, the sealing composition is present in the binder between encapsulated portions of an electrophoretic medium, for example, an electrophoretic medium encapsulated within a plurality of protein coacervate capsules.

In some embodiments, the polyhydroxy surfactant is a polyhydroxy acetylene moiety, for example of Formula I:

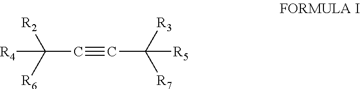

wherein R₂, R₃, R₄, R₅, R₆, and R₇ are independently H, C₁-C₃₆ branched or unbranched, saturated or unsaturated, alkyl, —OH, —(OCH₂)ₘOH, —(OCH₂CH₂)ₙOH, or —(OCH₂CHCH₃)ₚOH, wherein m, n, and p are integers from 1 to 30, and wherein at least two of R₂, R₃, R₄, R₅, R₆, and R₇ terminate in —OH. In some embodiments, R₂ and R₃ are —CH₃, and R₄ and R₅ are independently H, or a C₁-C₃₆ branched or unbranched, saturated or unsaturated, alkyl. Specifically, R₆ and R₇ may be —OH, —OCH₂OH, or —(OCH₂CHCH₃)₂OH, and R₄ and R₅ may be —CH₂CH(CH₃)₂, or —CH₂CH₂CH(CH₃)₂. In some instances the specific R₆ and R₇ moieties listed are combined with the specific R₄ and R₅ moieties listed. In some instances, the polyhydroxy acetylene moiety is 2,4,7,9-tetramethyldecyn-4,7-diol; 1,4-dimethyl-1,4-bis(2-methylpropyl)-2-butyne-1,4-diyl ether; or 2,5,8,11 tetramethyl 6 dodecyn-5,8 diol ethoxylate.

In other embodiments, the polyhydroxy surfactant is of Formula II:

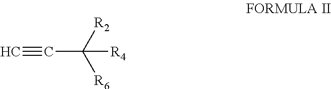

wherein R₂, R₄, and R₆ are independently H, C₁-C₃₆ branched or unbranched, saturated or unsaturated, alkyl, —OH, —(OCH₂)ₘOH, —(OCH₂CH₂)ₙOH, or —(OCH₂CHCH₃)ₚOH, wherein m, n, and p are integers from 1 to 30, and wherein at least one of R₂, R₄, and R₆ terminate in —OH. In some embodiments, R₂ is —CH₃, and R₄ is a C₁-C₃₆ branched or unbranched, saturated or unsaturated, alkyl. Specifically, R₆ may be —OH, —OCH₂OH, or —(OCH₂CHCH₃)₂OH, and R₄ may be —CH₂CH(CH₃)₂, or —CH₂CH₂CH(CH₃)₂. In some instances the specific R₆ moieties listed are combined with the specific R₄ moieties. In some instances, the polyhydroxy acetylene moiety is 3,5-dimethyl-1-hexyn-3-ol.

In other embodiments, the polyhydroxy surfactant is of Formula III:

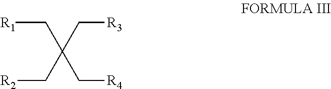

wherein R₁, R₂, R₃, and R₄ are independently selected from —OH, —(CH₂)ₘOH, —(OCH₂CH₂)ₙOH, —(OCH₂CHCH₃)_{q}OH, —OCOR₅, —(CH₂)ᵣOCOR₅, —(OCH₂CH₂)ₜOCOR₅, and —(OCH₂CHCH₃)ᵤOCOR₅, wherein each R₅ is independently a C₅-C₃₆ branched or unbranched alkane, fluoroalkane, or polyalkylsiloxane, and m, n, q, r, t, and u are independently integers from 1 to 30, and wherein at least one of R₁, R₂, R₃, or R₄ is —OCOR₅, —(CH₂)ᵣOCOR₅, —(OCH₂CH₂)ₜOCOR₅, or —(OCH₂CHCH₃)ᵤOCOR₅. In some instances, the polyhydroxy surfactant of Formula III includes R₁, R₂, and R₃ are —OH, R₄ is —OCOR₅, and R₅ is a C₅-C₃₆ branched or unbranched alkane, fluoroalkane, or polyalkylsiloxane, or R₁ and R₂ are —OH, and R₃ and R₄ are independently —OCOR₅, where each R₅ is a C₅-C₃₆ branched or unbranched alkane, fluoroalkane, or polyalkylsiloxane. In some instances R₅ is C₁₇H₃₅ or C₁₇F₃₅.

In other aspects, the invention provides a sealing composition for an electrophoretic display. The electrophoretic display includes a light-transmissive electrode, an electrophoretic medium including charged particles, and a sealing layer including the sealing composition. The sealing composition includes a polyhydroxy surfactant of Formula IV:

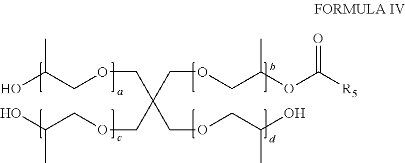

wherein a, b, c, and d are independently integers from 0-20, wherein at least one of a, b, c, and d is 1 or greater, and wherein R₅ is a C₅-C₃₆ branched or unbranched alkane, fluoroalkane, or polyalkylsiloxane. In some embodiments, R₅ is a C₁₀-C₂₀ unbranched alkane, fluoroalkane, or polyalkylsiloxane. R₅ may be saturated or unsaturated, R₅ may be C₁₇H₃₅ or C₁₇F₃₅, i.e., R₅ may be a stearate. In some embodiments of Formula IV, a, c, and d are 1, while b is optionally 2.

In other aspects, the invention provides a sealing composition for an electrophoretic display. The electrophoretic display includes a light-transmissive electrode, an electrophoretic medium including charged particles, and a sealing layer including the sealing composition. The sealing composition includes a polyhydroxy surfactant of Formula V:

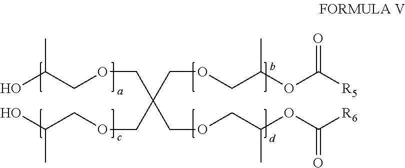

wherein a, b, c, and d are independently integers from 0-20, wherein at least one of a, b, c, and d is 1 or greater, and wherein R₅ is a C₅-C₃₆ branched or unbranched alkane, fluoroalkane, or polyalkylsiloxane. In some embodiments, R₅ is a C₁₀-C₂₀ unbranched alkane, fluoroalkane, or polyalkylsiloxane. R₅ may be saturated or unsaturated, R₅ may be C₁₇H₃₅ or C₁₇F₃₅, i.e., R₅ may be a stearate. In some embodiments of Formula IV, a and c are 1, while b and d are optionally 2.

In another aspect the invention provides a method for increasing the contrast between a first optical state and a second optical state in an electrophoretic display. The electrophoretic display includes a light-transmissive electrode, an electrophoretic medium including charged particles, and a sealing layer. The method includes adding a polyhydroxy surfactant to the sealing layer. In some embodiments, the electrophoretic medium does not comprise a polyhydroxy surfactant. In some embodiments, the electrophoretic medium is encapsulated, for example in a microcell or a protein coacervate. The microcells may be formed from a polymer, for example, a thermoplastic, or from a composition comprising a difunctional UV curable, a photoinitiator, and a release agent.

In some instances the method includes coating the microcells with a sealing layer and then filling the microcells with the electrophoretic medium. In some instances the microcells are filled with an electrophoretic medium and then the sealing layer is coated onto the filled microcells. In some embodiments, the polyhydroxy surfactant is a polyhydroxy acetylene moiety, such as of Formula I or II above, including any embodiments or species of Formulas I and II described above. In other embodiments, the polyhydroxy surfactant is a polyol of Formula III, IV, or V, including any embodiments or species of Formulas III, IV, and V described above.

The method for increasing the contrast between a first optical state and a second optical state in an electrophoretic display may be used in an electrophoretic medium having a plurality of charged particles dispersed in a non-polar fluid, wherein the charged particles are black, white red, green, blue, cyan, yellow, or magenta in color. In some instances, the non-polar fluid includes a mixture of branched hydrocarbons.

In another aspect, the invention includes a composition for binding encapsulated electrophoretic media comprising a polyhydroxy surfactant that is dispersible in the electrophoretic medium. The polyhydroxy surfactant can be of any of the polyhydroxy surfactants described above, e.g., of Formulas I-V, including any embodiments or species of Formulas I-V, described above. The electrophoretic media may be encapsulated in a protein coacervate while the composition is included in a binder that binds together the encapsulated electrophoretic media. In some instances, the composition additionally includes a polyurethane, and/or a latex, and/or a conductive filler. The conductive fillers may include, for example, graphite, graphene, metal filaments, metal particles, or carbon nanotubes.

### BRIEF DESCRIPTION OF FIGURES

FIG. 1 depicts an electrophoretic display in which the electrophoretic medium is encapsulated in microcells.

FIG. 2A shows an encapsulated electrophoretic film produced with an electrophoretic medium including a polyhydroxy surfactant.

FIG. 2B shows an encapsulated electrophoretic film produced with an electrophoretic medium having no polyhydroxy surfactants and wherein the polyhydroxy surfactant is included in the sealing layer.

FIG. 3A shows the improvement in white state reflectance in an electrophoretic display when a polyhydroxy acetylene surfactant is included in the sealing composition (TS-G4D1). In FIG. 3A, the electrophoretic medium did not have any polyhydroxy acetylene surfactant prior to encapsulation.

FIG. 3B demonstrates decreased white state image ghosting with the incorporation of a polyhydroxy acetylene surfactant in the sealing layer (TS-G4D1).

### DETAILED DESCRIPTION

The performance of various types of electrophoretic displays can be improved by including polyhydroxy surfactants in a sealing or binder layer of the electrophoretic display. For example, adding polyhydroxy surfactants to the sealing layer can improve the contrast between light (on) and dark (off) states in electrophoretic displays. Additionally, the additives decrease the incidence and intensity of leftover images after a display has been switched between images, a phenomenon known as “ghosting.” Furthermore, when the polyhydroxy surfactants are included in the sealing layer, but not included in the electrophoretic media, the electrophoretic display still achieves the performance improvements, presumably because of migration of the polyhydroxy surfactants from the sealing layer into the electrophoretic medium. In some embodiments, the polyhydroxy surfactants are included in a microcell layer or an adhesive layer of an electrophoretic display.

In some embodiments, the polyhydroxy surfactant is a polyhydroxy acetylene moiety, for example of Formula I:

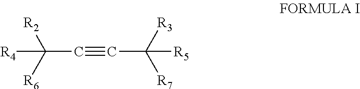

wherein R₂, R₃, R₄, R₅, R₆, and R₇ are independently H, C₁-C₃₆ branched or unbranched, saturated or unsaturated, alkyl, —OH, —(OCH₂)ₘOH, —(OCH₂CH₂)ₙOH, or —(OCH₂CHCH₃)ₚOH, wherein m, n, and p are integers from 1 to 30, and wherein at least two of R₂, R₃, R₄, R₅, R₆, and R₇ terminate in —OH. In some instances, the polyhydroxy acetylene moiety is 2,4,7,9-tetramethyldecyn-4,7-diol; 1,4-dimethyl-1,4-bis(2-methylpropyl)-2-butyne-1,4-diyl ether; or 2,5,8,11 tetramethyl 6 dodecyn-5,8 diol ethoxylate.

In other embodiments, the polyhydroxy surfactant is of Formula II:

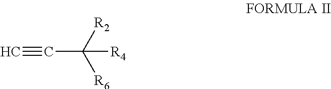

wherein R₂, R₄, and R₆ are independently H, C₁-C₃₆ branched or unbranched, saturated or unsaturated, alkyl, —OH, —(OCH₂)ₘOH, —(OCH₂CH₂)ₙOH, or —(OCH₂CHCH₃)ₚOH, wherein m, n, and p are integers from 1 to 30, and wherein at least one of R₂, R₄, and R₆ terminate in —OH. In some instances, the polyhydroxy acetylene moiety is 3,5-dimethyl-1-hexyn-3-ol.

In other embodiments, the polyhydroxy surfactant is of Formula III:

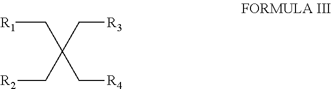

wherein R₁, R₂, R₃, and R₄ are independently selected from —OH, —(CH₂)ₘOH, —(OCH₂CH₂)ₙOH, —(OCH₂CHCH₃)_{q}OH, —OCOR₅, —(CH₂)ᵣOCOR₅, —(OCH₂CH₂)ₜOCOR₅, and —(OCH₂CHCH₃)ᵤOCOR₅, wherein each R₅ is independently a C₅-C₃₆ branched or unbranched alkane, fluoroalkane, or polyalkylsiloxane, and m, n, q, r, t, and u are independently integers from 1 to 30, and wherein at least one of R₁, R₂, R₃, or R₄ is —OCOR₅, —(CH₂)ᵣOCOR₅, —(OCH₂CH₂)ₜOCOR₅, or —(OCH₂CHCH₃)ᵤOCOR₅. In some instances, the polyhydroxy surfactant of Formula III includes R₁, R₂, and R₃ are —OH, R₄ is —OCOR₅, and R₅ is a C₅-C₃₆ branched or unbranched alkane, fluoroalkane, or polyalkylsiloxane, or R₁ and R₂ are —OH, and R₃ and R₄ are independently —OCOR₅, where each R₅ is a C₅-C₃₆ branched or unbranched alkane, fluoroalkane, or polyalkylsiloxane. In some instances R₅ is C₁₇H₃₅ or C₁₇F₃₅.

In other aspects, the invention provides a sealing composition for an electrophoretic display. The electrophoretic display includes a light-transmissive electrode, an electrophoretic medium including charged particles, and a sealing layer including the sealing composition. The sealing composition includes a polyhydroxy surfactant of Formula IV:

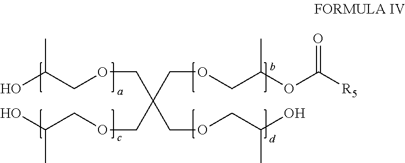

wherein a, b, c, and d are independently integers from 0-20, wherein at least one of a, b, c, and d is 1 or greater, and wherein R₅ is a C₅-C₃₆ branched or unbranched alkane, fluoroalkane, or polyalkylsiloxane. In some embodiments, R₅ is a C₁₀-C₂₀ unbranched alkane, fluoroalkane, or polyalkylsiloxane. R₅ may be saturated or unsaturated, R₅ may be C₁₇H₃₅ or C₁₇F₃₅, i.e., R₅ may be a stearate. In some embodiments of Formula IV, a, c, and d are 1, while b is optionally 2.

In other aspects, the invention provides a sealing composition for an electrophoretic display. The electrophoretic display includes a light-transmissive electrode, an electrophoretic medium including charged particles, and a sealing layer including the sealing composition. The sealing composition includes a polyhydroxy surfactant of Formula V:

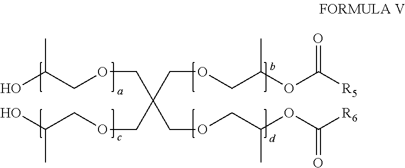

wherein a, b, c, and d are independently integers from 0-20, wherein at least one of a, b, c, and d is 1 or greater, and wherein R₅ is a C₅-C₃₆ branched or unbranched alkane, fluoroalkane, or polyalkylsiloxane. In some embodiments, R₅ is a C₁₀-C₂₀ unbranched alkane, fluoroalkane, or polyalkylsiloxane. R₅ may be saturated or unsaturated, R₅ may be C₁₇H₃₅ or C₁₇F₃₅, i.e., R₅ may be a stearate. In some embodiments of Formula IV, a and c are 1, while b and d are optionally 2.

As described in the Background, the electrophoretic medium may be encapsulated, for example in a microcell or a protein coacervate. The microcells may be formed from a polymer, via imprinting, thermosetting, or molding, as described below. The microcells may be formed from a thermoplastic or a composition comprising a difunctional UV curable component, a photoinitiator, and a release agent. In yet other embodiments, the electrophoretic medium may be dispersed as droplets in a polymer.

The sealing composition may be prepared from a variety of suitable polymers, such as acrylics, styrene-butadiene copolymers, styrene-butadiene-styrene block copolymers, styrene-isoprene-styrene block copolymers, polyvinylbutyral, cellulose acetate butyrate, polyvinylpyrrolidone, polyurethanes, polyamides, ethylene-vinylacetate copolymers, epoxides, multifunctional acrylates, vinyls, vinylethers, polyvinyl alcohol; polyethylene glycol, polypropylene glycol; polysaccharides; gelatin polyacrylamide; polymethacrylamide, thermoplastic or thermoset and their precursors thereof. Specific examples may include materials such as monofunctional acrylates, monofunctional methacrylates, multifunctional acrylates, multifunctional methacrylates, polyvinyl alcohol, polyacrylic acid, cellulose, gelatin or the like. Additives such as a polymeric binder or thickener, photoinitiator, catalyst, vulcanizer, filler, or colorant may also be added to the sealing composition to improve the physico-mechanical properties and the optical properties of the display. The sealing compositions may also include conductive fillers such as graphite, graphene, metal filaments, metal particles, or carbon nanotubes. In some instances, the sealing composition includes 0.01% to 7% by weight of carbon nanotubes and 0.1% to 20% by weight of graphite.

For an organic-based display fluid, the sealing material may be a water soluble polymer with water as the sealing solvent. Examples of suitable water soluble polymers or water soluble polymer precursors may include, but are not limited to, polyvinyl alcohol; polyethylene glycol, its copolymers with polypropylene glycol, and its derivatives, such as PEG-PPG-PEG, PPG-PEG, PPG-PEG-PPG; poly(vinylpyrrolidone) and its copolymers such as poly(vinylpyrrolidone)/vinyl acetate (PVP/VA); polysaccharides such as cellulose and its derivatives, poly(glucosamine), dextran, guar gum, and starch; gelatin; melamine-formaldehyde; poly(acrylic acid), its salt forms, and its copolymers; poly(methacrylic acid), its salt forms, and its copolymers; poly(maleic acid), its salt forms, and its copolymers; poly(2-dimethylaminoethyl methacrylate); poly(2-ethyl-2-oxazoline); poly(2-vinylpyridine); poly(allylamine); polyacrylamide; polyethylenimine; polymethacrylamide; poly(sodium styrene sulfonate); cationic polymer functionalized with quaternary ammonium groups, such as poly(2-methacryloxyethyltrimethylammonium bromide), poly(allylamine hydrochloride). The sealing material may also include a water dispersible polymer with water as a formulating solvent. Examples of suitable polymer water dispersions may include polyurethane water dispersion and latex water dispersion. Suitable latexes in the water dispersion include polyacrylate, polyvinyl acetate and its copolymers such as ethylene vinyl acetate, and polystyrene copolymers such as polystyrene butadiene and polystyrene/acrylate.

Polyhydroxy surfactants suitable for use in sealing compositions of the invention include commercially-available polyhydroxy surfactants as well as novel polyhydroxy surfactants such as those disclosed in the U.S. Provisional Patent Application “ADDITIVES FOR ELECTROPHORETIC MEDIA” docket 76614-8470.US00 filed on this date, and incorporated by reference in its entirety. For example, several members of the SURFYNOL family of surfactants, available from Air Products (Allentown, Pa.), are suitable polyhydroxylated acetylene derivatives. Specifically, 2,4,7,9-tetramethyldecyn-4,7-diol (SURFYNOL 104; also “TDD”), 3,5-dimethyl-1-hexyn-3-ol (SURFYNOL 61), 1,4-dimethyl-1,4-bis(2-methylpropyl)-2-butyne-1,4-diyl ether (SURFYNOL 2502) are suitable for use in the methods of the invention. Other commercially-available surfactants include other members of the SURFYNOL family, for example, SURFYNOL 104A, SURFYNOL 104E, SURFYNOL 104DPM, SURFYNOL 104H, SURFYNOL 104BC, SURFYNOL 104PA, SURFYNOL 104PG-50, SURFYNOL 104S, SURFYNOL 420, SURFYNOL 440, SURFYNOL SE-F, SURFYNOL PC, SURFYNOL 82, SURFYNOL MD-610S, SURFYNOL MD-20 and SURFYNOL DF-110D In other embodiments, proprietary polyhydroxylated acetylene derivatives sold under the name CARBOWET (Air Products) can be used with the methods of the invention. These include CARBOWET GA-210, 76, CARBOWET GA-221, CARBOWET GA-211, CARBOWET GA-100, and CARBOWET 106. Other suitable polyhydroxylated acetylene surfactants include DYNOL surfactants (Air Products) such as DYNOL 360 (2,5,8,11 tetramethyl 6 dodecyn-5,8 diol ethoxylate), DYNOL 604 (2,5,8,11 tetramethyl 6 dodecyn-5,8 diol ethoxylate) and DYNOL 607 (2,5,8,11 tetramethyl 6 dodecyn-5,8 diol ethoxylate).

In addition to the polyhydroxylated acetylene derivatives above, electrophoretic media may also include other polyhydroxy surfactant families, such as SPANS (sorbitan derivatives), available from Sigma-Aldrich, including SPAN 20, SPAN 60, SPAN 80, SPAN 83, SPAN 85, and SPAN 120 and TWEENS (polyethylene glycol sorbitan derivatives), also available from Sigma-Aldrich.

Commercially-available branched polyhydroxy surfactants may include branched polyols, such as pentaerythritol propoxylate, pentaerythritol monostearate, and related polyols, available from Sigma-Aldrich (Milwaukee, Wis.). Novel polyhydroxy surfactants may be synthesized by esterifying branched polyols and fatty acids such as pentaerythritol propoxylate (5/4 PO/OH) and stearic acid. The fatty acids may be saturated or unsaturated, branched or unbranched. In some embodiments, the fatty acids are perfluorinated, or partially fluorinated. In some embodiments, the branched polyol will include oligomers of polypropylene oxide or polyethylene oxide. Many suitable polyols are available from commercial suppliers, such as Sigma-Aldrich.

The polyhydroxy surfactants may be added to the sealing layer composition at a concentration of greater than 0.01% (wt/wt) by solid [surfactant/sealing layer], i.e., greater than 0.1% (wt/wt), i.e., greater than 0.5% (wt/wt), i.e., greater than 1% (wt/wt), i.e., greater than 2% (wt/wt), i.e., greater than 3% (wt/wt), i.e., greater than 5% (wt/wt). In some electrophoretic displays, the electrophoretic medium will not comprise any polyhydroxy surfactant. In other electrophoretic displays, only a small amount of polyhydroxy surfactant will be included in the electrophoretic medium, i.e., less than 1%, i.e., less than 0.5%, i.e., less than 0.1%, i.e., less than 0.01%.

Sealing compositions of the invention can be used with electrophoretic media that include functionalized pigments in an organic solvent. The media may be incorporated into displays, or into front plane laminates or inverted front plane laminates that are coupled to a backplane to make a display. Electrophoretic media of the invention, i.e., including additives of the invention, may include only black and white pigments, i.e., for use in black/white displays. Electrophoretic media of the invention may also be used in colors displays, i.e., including, for example, three, four, five, six, seven, or eight different types of particles. For examples, a display may be constructed where the particles include black, white, and red or black, white, and yellow. Alternatively, the display may include red, green, and blue particles, or cyan, magenta, and yellow particles, or red, green, blue, and yellow particles.

The term gray state is used herein in its conventional meaning in the imaging art to refer to a state intermediate two extreme optical states of a pixel, and does not necessarily imply a black-white transition between these two extreme states. For example, several of the E Ink patents and published applications referred to below describe electrophoretic displays in which the extreme states are white and deep blue, so that an intermediate gray state would actually be pale blue. Indeed, as already mentioned, the change in optical state may not be a color change at all. The terms black and white may be used hereinafter to refer to the two extreme optical states of a display, and should be understood as normally including extreme optical states which are not strictly black and white, for example the aforementioned white and dark blue states.

The terms bistable and bistability are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, for example at least four times, the minimum duration of the addressing pulse required to change the state of the display element. It is shown in U.S. Pat. No. 7,170,670 that some particle-based electrophoretic displays capable of gray scale are stable not only in their extreme black and white states but also in their intermediate gray states, and the same is true of some other types of electro-optic displays. This type of display is properly called multi-stable rather than bistable, although for convenience the term bistable may be used herein to cover both bistable and multi-stable displays.

Many of the aforementioned patents and applications recognize that the walls surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet; see for example, U.S. Pat. No. 6,866,760. Accordingly, for purposes of the present application, such polymer-dispersed electrophoretic media are regarded as sub-species of encapsulated electrophoretic media.

A related type of electrophoretic display is a so-called microcell electrophoretic display. In a microcell electrophoretic display, the charged particles and the fluid are not encapsulated within microcapsules but instead are retained within a plurality of cavities formed within a carrier medium, typically a polymeric film. See, for example, U.S. Pat. Nos. 6,672,921 and 6,788,449, both of which are incorporated herein by reference.

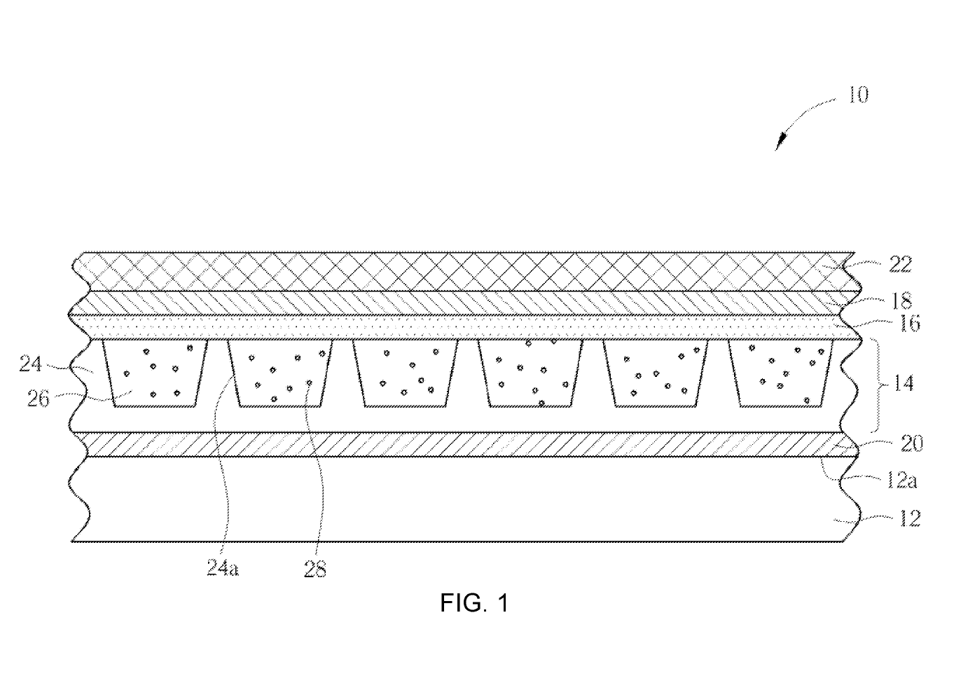

An exemplary electrophoretic microcell display is shown in FIG. 1. An electrophoretic microcell display 10 includes at least a substrate 12 and an electrophoretic medium layer 14 positioned on a side of the substrate 12. The electrophoretic medium layer 14 includes an electrophoretic medium, which may include a fluid 26 and charged particles 28 that move in the influence of an electric field. The electrophoretic microcell display 10 may include a plurality of microcell structures 24 arranged as a matrix on the surface 12a of the substrate 12. The microcell structures 24 are formed with dielectric material, typically a polymer, and each microcell structure 24 has a containing space 24a used for containing the electrophoretic medium. Therefore, the microcell structures 24 are disposed within the display medium layer 14. The electrophoretic microcell display 10 further includes at least two additional layers, wherein one is a sealing layer 16 disposed on the electrophoretic medium layer 14, comprising a sealing composition, and the other one is an adhesive layer 18 disposed on the sealing layer 16. The sealing layer 16 is used for sealing the electrophoretic medium within the microcell structures 24. The adhesive layer 18 is used to attach a control element layer 22 to the sealing layer 16 and the electrophoretic medium layer 14. Accordingly, both the adhesive layer 18 and the sealing layer 16 are disposed at a side of the electrophoretic medium layer 14 opposite to the substrate 12. The control element layer 22 may include transparent conductive material, such as indium tin oxide (ITO) and indium zinc oxide (IZO), and/or transistors arranged as an array, so as to provide operation voltages to the display 10. In addition, a conductive layer 20 may be disposed between the substrate 12 and the electrophoretic medium layer 14, wherein the conductive layer 20 includes a conductive material, such as ITO, IZO, metal, or other conductive elements such as graphite. The control element layer 22 and the conductive layer 20 serve as the top electrode and the bottom electrode of the electrophoretic microcell display 10 respectively. In some embodiments, the electrophoretic microcell display 10 also includes a barrier layer or a passivation layer (not shown) disposed on the control element layer. The entire electrophoretic microcell display 10 may be packaged or sealed to prevent ingress of liquids or gas. As described previously, polyhydroxy sealing formulations can be incorporated into many different structures in the microcell display 10. For example, polyhydroxy additives are included in a microcell layer or an adhesive layer of an electrophoretic display.

As noted above, electrophoretic media require the presence of a fluid. In most prior art electrophoretic media, this fluid is a liquid, but electrophoretic media can be produced using gaseous fluids; see, for example, Kitamura, T., et al., Electrical toner movement for electronic paper-like display, IDW Japan, 2001, Paper HCS1-1, and Yamaguchi, Y., et al., Toner display using insulative particles charged triboelectrically, IDW Japan, 2001, Paper AMD4-4). See also U.S. Pat. Nos. 7,321,459 and 7,236,291. Such gas-based electrophoretic media appear to be susceptible to the same types of problems due to particle settling as liquid-based electrophoretic media, when the media are used in an orientation which permits such settling, for example in a sign where the medium is disposed in a vertical plane. Indeed, particle settling appears to be a more serious problem in gas-based electrophoretic media than in liquid-based ones, since the lower viscosity of gaseous suspending fluids as compared with liquid ones allows more rapid settling of the electrophoretic particles.

An encapsulated electrophoretic display typically does not suffer from the clustering and settling failure mode of traditional electrophoretic devices and provides further advantages, such as the ability to print or coat the display on a wide variety of flexible and rigid substrates. (Use of the word printing is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; electrophoretic deposition (See U.S. Pat. No. 7,339,715); and other similar techniques.) Thus, the resulting display can be flexible. Further, because the display medium can be printed (using a variety of methods), the display itself can be made inexpensively.

The aforementioned U.S. Pat. No. 6,982,178 describes a method of assembling electrophoretic displays (including an encapsulated electrophoretic display). Essentially, this patent describes a so-called front plane laminate (FPL) which comprises, in order, a light-transmissive electrically-conductive layer; a layer of a solid electro-optic medium in electrical contact with the electrically-conductive layer; an adhesive layer; and a release sheet. Typically, the light-transmissive electrically-conductive layer will be carried on a light-transmissive substrate, which is preferably flexible, in the sense that the substrate can be manually wrapped around a drum (say) 10 inches (254 mm) in diameter without permanent deformation. The term light-transmissive is used in this patent and herein to mean that the layer thus designated transmits sufficient light to enable an observer, looking through that layer, to observe the change in display states of the electro-optic medium, which will normally be viewed through the electrically-conductive layer and adjacent substrate (if present); in cases where the electro-optic medium displays a change in reflectivity at non-visible wavelengths, the term light-transmissive should of course be interpreted to refer to transmission of the relevant non-visible wavelengths. The substrate will typically be a polymeric film, and will normally have a thickness in the range of about 1 to about 25 mil (25 to 634 μm), preferably about 2 to about 10 mil (51 to 254 μm). The electrically-conductive layer is conveniently a thin metal or metal oxide layer of, for example, aluminum or indium tin oxide (ITO), or may be a conductive polymer. Poly(ethylene terephthalate) (PET) films coated with aluminum or ITO are available commercially, for example as aluminized MYLAR (DuPont), and such commercial materials may be used with good results in the front plane laminate.

Assembly of an electro-optic display using such a front plane laminate may be effected by removing the release sheet from the front plane laminate and contacting the adhesive layer with the backplane under conditions effective to cause the adhesive layer to adhere to the backplane, thereby securing the adhesive layer, layer of electro-optic medium and electrically-conductive layer to the backplane. This process is well-adapted to mass production since the front plane laminate may be mass produced, typically using roll-to-roll coating techniques, and then cut into pieces of any size needed for use with specific backplanes.

Electrophoretic media may also include charge control agents (CCAs). For example, pigment particles may be functionalized or surface coated with charged or chargeable groups. The CCAs may be absorbed into the particles, they may be covalently bound to the surface of the particles, and they may exist in a charge complex, or be loosely associated via van der Waals forces. Charge control agents comprising a quaternary amine and an unsaturated polymeric tail comprising monomers of at least 10 carbon atoms in length are preferred. Quaternary amines comprise a quaternary ammonium cation [NRiR₂R₃R₄]⁺ bonded to an organic molecule, for example an alkyl group or an aryl group. Quaternary amine charge control agents typically include a long non-polar tail attached to the charged ammonium cation, such as the families of fatty acid quaternary amines offered by Akzo Nobel under the tradenames ARQUAD. The quaternary amine charge control agents may be purchased in a purified form, or the charge control agents may be purchased as a reaction product that has formed a quaternary amine charge control agent. For example, SOLSPERSE 17000 (Lubrizol Corporation), may be purchased as a reaction product of 12-hydroxy-octadecanoic acid homopolymer with N,N-dimethyl-1,3-propanediamine and methylbisulfate. Other useful ionic charge control agents include, but are not limited to, sodium dodecylbenzenesulfonate, metal soap, polybutene succinimide, maleic anhydride copolymers, vinylpyridine copolymers, vinylpyrrolidone copolymer, (meth)acrylic acid copolymers or N,N-dimethylaminoethyl(meth)acrylate copolymers), Alcolec LV30 (soy lecithin), Petrostep B100 (petroleum sulfonate) or B70 (barium sulfonate), OLOA 11000 (succinimide ashless dispersant), OLOA 1200 (polyisobutylene succinimides), Unithox 750 (ethoxylates), Petronate L (sodium sulfonate), Disper BYK 101, 2095, 185, 116, 9077 & 220 and ANTITERRA series.

The charge control agents may be added to the electrophoretic medium at a concentration of greater than 1 g of charge control agent for every 100 g of charged particles. For example, the charge control agent to charged particle ratio may be 1:30 (wt/wt), e.g., 1:25 (wt/wt), e.g., 1:20 (wt/wt). The charge control agents may have an average molecular weight of greater than 12,000 grams/mole, e.g., greater than 13,000 grams/mole, e.g., greater than 14,000 grams/mole, e.g., greater than 15,000 grams/mole, e.g., greater than 16,000 grams/mole, e.g., greater than 17,000 grams/mole, e.g., greater than 18,000 grams/mole, e.g., greater than 19,000 grams/mole, e.g., greater than 20,000 grams/mole, e.g., greater than 21,000 grams/mole. For example, the average molecular weight of the charge control agent may be between 14,000 grams/mole and 22,000 grams/mole, e.g., between 15,000 grams/mole and 20,000 grams/mole. In some embodiments, the charge control agents have an average molecular weight of about 19,000 grams/mole.

Additional charge control agents may be used, with or without charged groups in polymer coatings, to provide good electrophoretic mobility to the electrophoretic particles. Stabilizers may be used to prevent agglomeration of the electrophoretic particles, as well as prevent the electrophoretic particles from irreversibly depositing onto the capsule wall. Either component can be constructed from materials across a wide range of molecular weights (low molecular weight, oligomeric, or polymeric), and may be a single pure compound or a mixture. An optional charge control agent or charge director may be used. These constituents typically consist of low molecular weight surfactants, polymeric agents, or blends of one or more components and serve to stabilize or otherwise modify the sign and/or magnitude of the charge on the electrophoretic particles. Additional pigment properties which may be relevant are the particle size distribution, the chemical composition, and the lightfastness.

As already indicated, the suspending fluid containing the particles should be chosen based on properties such as density, refractive index, and solubility. A preferred suspending fluid has a low dielectric constant (about 2), high volume resistivity (about 1015 ohm-cm), low viscosity (less than 5 centistokes (“cst”)), low toxicity and environmental impact, low water solubility (less than 10 parts per million (“ppm”)), high specific gravity (greater than 1.5), a high boiling point (greater than 90° C.), and a low refractive index (less than 1.2).

The choice of non-polar fluid may be based on concerns of chemical inertness, density matching to the electrophoretic particle, or chemical compatibility with both the electrophoretic particle and bounding capsule (in the case of encapsulated electrophoretic displays). The viscosity of the fluid should be low when movement of the particles is desired. The refractive index of the suspending fluid may also be substantially matched to that of the particles. As used herein, the refractive index of a suspending fluid “is substantially matched” to that of a particle if the difference between their respective refractive indices is between about zero and about 0.3, and is preferably between about 0.05 and about 0.2.

Non-polar organic solvents, such as halogenated organic solvents, saturated linear or branched hydrocarbons, silicone oils, and low molecular weight halogen-containing polymers are some useful non-polar fluids. The non-polar fluid may comprise a single fluid. The non-polar fluid will, however, often be a blend of more than one fluid in order to tune its chemical and physical properties. Furthermore, the non-polar fluid may contain additional surface modifiers to modify the surface energy or charge of the electrophoretic particle or bounding capsule. Reactants or solvents for the microencapsulation process (oil soluble monomers, for example) can also be contained in the suspending fluid. Additional charge control agents can also be added to the suspending fluid.

Useful organic solvents include, but are not limited to, epoxides, such as decane epoxide and dodecane epoxide; vinyl ethers, such as cyclohexyl vinyl ether and Decave (Registered Trade Mark of International Flavors & Fragrances, Inc., New York, N.Y.); and aromatic hydrocarbons, such as toluene and naphthalene. Useful halogenated organic solvents include, but are not limited to, tetrafluorodibromoethylene, tetrachloroethylene, trifluorochloroethylene, 1,2,4-trichlorobenzene and carbon tetrachloride. These materials have high densities. Useful hydrocarbons include, but are not limited to, dodecane, tetradecane, the aliphatic hydrocarbons in the Isopar (Registered Trade Mark) series (Exxon, Houston, Tex.), Norpar (Registered Trade Mark) (a series of normal paraffinic liquids), Shell-Sol (Registered Trade Mark) (Shell, Houston, Tex.), and Sol-Trol (Registered Trade Mark) (Shell), naphtha, and other petroleum solvents. These materials usually have low densities. Useful examples of silicone oils include, but are not limited to, octamethyl cyclosiloxane and higher molecular weight cyclic siloxanes, poly(methyl phenyl siloxane), hexamethyldisiloxane, and polydimethylsiloxane. These materials usually have low densities. Useful low molecular weight halogen-containing polymers include, but are not limited to, poly(chlorotrifluoroethylene) polymer (Halogenated Hydrocarbon Inc., River Edge, N.J.), Galden (Registered Trade Mark) (a perfluorinated ether from Ausimont, Morristown, N.J.), or Krytox (Registered Trade Mark) from du Pont (Wilmington, Del.). In a preferred embodiment, the suspending fluid is a poly (chlorotrifluoroethylene) polymer. In a particularly preferred embodiment, this polymer has a degree of polymerization from about 2 to about 10. Many of the above materials are available in a range of viscosities, densities, and boiling points.

It some embodiments, the non-polar fluid will include an optically absorbing dye. This dye must be soluble in the fluid, but will generally be insoluble in the other components of the capsule. There is much flexibility in the choice of dye material. The dye can be a pure compound, or blends of dyes to achieve a particular color, including black. The dyes can be fluorescent, which would produce a display in which the fluorescence properties depend on the position of the particles. The dyes can be photoactive, changing to another color or becoming colorless upon irradiation with either visible or ultraviolet light, providing another means for obtaining an optical response. Dyes could also be polymerizable by, for example, thermal, photochemical or chemical diffusion processes, forming a solid absorbing polymer inside the bounding shell.

A number of dyes already known to those skilled in the art of electrophoretic displays will prove useful. Useful azo dyes include, but are not limited to: the Oil Red dyes, and the Sudan Red and Sudan Black series of dyes. Useful anthraquinone dyes include, but are not limited to: the Oil Blue dyes, and the Macrolex Blue series of dyes. Useful triphenylmethane dyes include, but are not limited to, Michler's hydrol, Malachite Green, Crystal Violet, and Auramine O. The core particle may be of an inorganic pigment such as TiO₂, ZrO₂, ZnO, Al₂O₃, CI pigment black 26 or 28 or the like (e.g., manganese ferrite black spinel or copper chromite black spinel), or an organic pigment such as phthalocyanine blue, phthalocyanine green, diarylide yellow, diarylide AAOT yellow, and quinacridone, azo, rhodamine, perylene pigment series from Sun Chemical, Hansa yellow G particles from Kanto Chemical, and Carbon Lampblack from Fisher or the like.

Particle dispersion stabilizers may also be added to prevent particle flocculation or attachment to the capsule walls. For the typical high resistivity liquids used as suspending fluids in electrophoretic displays, non-aqueous surfactants may be used. These include, but are not limited to, glycol ethers, acetylenic glycols, alkanolamides, sorbitol derivatives, alkyl amines, quaternary amines, imidazolines, dialkyl oxides, and sulfosuccinates.

If a bistable electrophoretic medium is desired, it may be desirable to include in the suspending fluid a polymer having a number average molecular weight in excess of about 20,000, this polymer being essentially non-absorbing on the electrophoretic particles; poly(isobutylene) is a preferred polymer for this purpose. See U.S. Pat. No. 7,170,670, the entire disclosure of which is herein incorporated by reference.

Encapsulation of the internal phase may be accomplished in a number of different ways. Numerous suitable procedures for microencapsulation are detailed in both Microencapsulation, Processes and Applications, (I. E. Vandegaer, ed.), Plenum Press, New York, N.Y. (1974) and Gutcho, Microcapsules and Microencapsulation Techniques, Noyes Data Corp., Park Ridge, N.J. (1976). The processes fall into several general categories, all of which can be applied to the present invention: interfacial polymerization, in situ polymerization, physical processes, such as coextrusion and other phase separation processes, in-liquid curing, and simple/complex coacervation.

Numerous materials and processes should prove useful in formulating displays of the present invention. Useful materials for simple coacervation processes to form the capsule include, but are not limited to, gelatin, poly(vinyl alcohol), poly(vinyl acetate), and cellulosic derivatives, such as, for example, carboxymethylcellulose. Useful materials for complex coacervation processes include, but are not limited to, gelatin, acacia, carageenan, carboxymethylcellulose, hydrolyzed styrene anhydride copolymers, agar, alginate, casein, albumin, methyl vinyl ether co-maleic anhydride, and cellulose phthalate. Useful materials for phase separation processes include, but are not limited to, polystyrene, poly(methyl methacrylate) (PMMA), poly(ethyl methacrylate), poly(butyl methacrylate), ethyl cellulose, poly(vinylpyridine), and polyacrylonitrile. Useful materials for in situ polymerization processes include, but are not limited to, polyhydroxyamides, with aldehydes, melamine, or urea and formaldehyde; water-soluble oligomers of the condensate of melamine, or urea and formaldehyde; and vinyl monomers, such as, for example, styrene, methyl methacrylate (MMA) and acrylonitrile. Finally, useful materials for interfacial polymerization processes include, but are not limited to, diacyl chlorides, such as, for example, sebacoyl, adipoyl, and di- or poly-amines or alcohols, and isocyanates. Useful emulsion polymerization materials may include, but are not limited to, styrene, vinyl acetate, acrylic acid, butyl acrylate, t-butyl acrylate, methyl methacrylate, and butyl methacrylate.

Capsules produced may be dispersed into a curable carrier, resulting in an ink which may be printed or coated on large and arbitrarily shaped or curved surfaces using conventional printing and coating techniques.

In the context of the present invention, one skilled in the art will select an encapsulation procedure and wall material based on the desired capsule properties. These properties include the distribution of capsule radii; electrical, mechanical, diffusion, and optical properties of the capsule wall; and chemical compatibility with the internal phase of the capsule.

The capsule wall generally has a high electrical resistivity. Although it is possible to use walls with relatively low resistivities, this may limit performance in requiring relatively higher addressing voltages. The capsule wall should also be mechanically strong (although if the finished capsule powder is to be dispersed in a curable polymeric binder for coating, mechanical strength is not as critical). The capsule wall should generally not be porous. If, however, it is desired to use an encapsulation procedure that produces porous capsules, these can be overcoated in a post-processing step (i.e., a second encapsulation). Moreover, if the capsules are to be dispersed in a curable binder, the binder will serve to close the pores. The capsule walls should be optically clear. The binder typically is used as an adhesive medium that supports and protects the capsules, as well as binds the electrode materials to the capsule dispersion. A binder can be non-conducting, semiconductive, or conductive. Binders are available in many forms and chemical types. Among these are water-soluble polymers, water-borne polymers, oil-soluble polymers, thermoset and thermoplastic polymers, and radiation-cured polymers.

Among the water-soluble polymers are the various polysaccharides, the polyvinyl alcohols, N-methylpyrrolidone, N-vinylpyrrolidone, the various CARBOWAX species (Union Carbide, Danbury, Conn.), and poly(2-hydroxyethyl acrylate). The water-dispersed or water-borne systems are generally latex compositions, typified by the NEOREX and NEOCRYL resins (Zeneca Resins, Wilmington, Mass.), ACRYSOL (Rohm and Haas, Philadelphia, Pa.), BAYHYDROL (Bayer, Pittsburgh, Pa.), and the Cytec Industries (West Paterson, N.J.) HP line. These are generally lattices of polyurethanes, occasionally compounded with one or more of the acrylics, polyesters, polycarbonates or silicones, each lending the final cured resin in a specific set of properties defined by glass transition temperature, degree of “tack”, softness, clarity, flexibility, water permeability and solvent resistance, elongation modulus and tensile strength, thermoplastic flow, and solids level. Some water-borne systems can be mixed with reactive monomers and catalyzed to form more complex resins. Some can be further cross-linked by the use of a cross-linking reagent, such as an aziridine, for example, which reacts with carboxyl groups.

An encapsulation technique that is suited to the present invention involves a polymerization between urea and formaldehyde in an aqueous phase of an oil/water emulsion in the presence of a negatively charged, carboxyl-substituted, linear hydrocarbon polyelectrolyte material. The resulting capsule wall is a urea/formaldehyde copolymer, which discretely encloses the internal phase. The capsule is clear, mechanically strong, and has good resistivity properties.

The related technique of in situ polymerization utilizes an oil/water emulsion, which is formed by dispersing the electrophoretic fluid (i.e., the dielectric liquid containing a suspension of the pigment particles) in an aqueous environment. The monomers polymerize to form a polymer with higher affinity for the internal phase than for the aqueous phase, thus condensing around the emulsified oily droplets. In one in situ polymerization process, urea and formaldehyde condense in the presence of poly(acrylic acid) (see, e.g., U.S. Pat. No. 4,001,140). In other processes, described in U.S. Pat. No. 4,273,672, any of a variety of cross-linking agents borne in aqueous solution is deposited around microscopic oil droplets. Such cross-linking agents include aldehydes, especially formaldehyde, glyoxal, or glutaraldehyde; alum; zirconium salts; and polyisocyanates.

The coacervation approach also utilizes an oil/water emulsion. One or more colloids are coacervated (i.e., agglomerated) out of the aqueous phase and deposited as shells around the oily droplets through control of temperature, pH and/or relative concentrations, thereby creating the microcapsule. Materials suitable for coacervation include gelatins and gum arabic. See, e.g., U.S. Pat. No. 2,800,457.

The interfacial polymerization approach relies on the presence of an oil-soluble monomer in the electrophoretic composition, which once again is present as an emulsion in an aqueous phase. The monomers in the minute hydrophobic droplets react with a monomer introduced into the aqueous phase, polymerizing at the interface between the droplets and the surrounding aqueous medium and forming shells around the droplets. Although the resulting walls are relatively thin and may be permeable, this process does not require the elevated temperatures characteristic of some other processes, and therefore affords greater flexibility in terms of choosing the dielectric liquid.

Additional materials may be added to encapsulated medium to improve the construction of an electrophoretic display. For example, coating aids can be used to improve the uniformity and quality of the coated or printed electrophoretic ink material. Wetting agents may be added to adjust the interfacial tension at the coating/substrate interface and to adjust the liquid/air surface tension. Wetting agents include, but are not limited to, anionic and cationic surfactants, and nonionic species, such as silicone or fluoropolymer-based materials. Dispersing agents may be used to modify the interfacial tension between the capsules and binder, providing control over flocculation and particle settling.

In other embodiments, the electrophoretic medium may be contained in microfabricated cells, i.e., microcells, such as fabricated by E Ink under the tradename MICROCUP. Once the microcells are filled with the electrophoretic medium, the microcells are sealed, an electrode (or an electrode array) is affixed to the microcells, and the filled microcells are driven with electric fields to create a display.

For example, as described in U.S. Pat. No. 6,930,818, a male mold may be used to imprint a conductive substrate, upon which is formed a transparent conductor film. A layer of a thermoplastic or thermoset precursor is then coated on the conductor film. The thermoplastic or thermoset precursor layer is embossed at a temperature higher than the glass transition temperature of the thermoplastic or thermoset precursor layer by the male mold in the form of a roller, plate or belt. Once formed, the mold is released during or after the precursor layer is hardened to reveal an array of microcells. The hardening of the precursor layer may be accomplished by cooling, cross-linking by radiation, heat or moisture. If the curing of the thermoset precursor is accomplished by UV radiation, UV may radiate onto the transparent conductor film from the bottom or the top of the web as shown in the two figures. Alternatively, UV lamps may be placed inside the mold. In this case, the mold must be transparent to allow the UV light to radiate through the pre-patterned male mold on to the thermoset precursor layer.

The thermoplastic or thermoset precursor for the preparation of the microcells may be multifunctional acrylate or methacrylate, vinylether, epoxide and their oligomers, polymers and the like. A crosslinkable oligomer imparting flexibility, such as urethane acrylate or polyester acrylate, is usually also added to improve the flexure resistance of the embossed microcells. The composition may contain polymer, oligomer, monomer and additives or only oligomer, monomer and additives.

In general, the microcells can be of any shape, and their sizes and shapes may vary. The microcells may be of substantially uniform size and shape in one system. However, in order to maximize the optical effect, microcells having a mixture of different shapes and sizes may be produced. For example, microcells filled with a dispersion of the red color may have a different shape or size from the green microcells or the blue microcells. Furthermore, a pixel may consist of different numbers of microcells of different colors. For example, a pixel may consist of a number of small green microcells, a number of large red microcells, and a number of small blue microcells. It is not necessary to have the same shape and number for the three colors.

The openings of the microcells may be round, square, rectangular, hexagonal, or any other shape. The partition area between the openings is preferably kept small in order to achieve a high color saturation and contrast while maintaining desirable mechanical properties. Consequently the honeycomb-shaped opening is preferred over, for example, the circular opening.

For reflective electrophoretic displays, the dimension of each individual microcell may be in the range of about 10² to about 5×10⁵ m², preferably from about 10³ about 5×10⁴ μm². The depth of the microcells is in the range of about 3 to about 100 microns, preferably from about 10 to about 50 microns. The opening to wall ratio is in the range of from about 0.05 to about 100, preferably from about 0.4 to about 20. The distances of the openings usually are in the range of from about 15 to about 450 microns, preferably from about 25 to about 300 microns from edge to edge of the openings.

Taken together, it will be apparent to those skilled in the art that numerous changes and modifications can be made in the specific embodiments of the invention described above without departing from the scope of the invention. Accordingly, the whole of the foregoing description is to be interpreted in an illustrative and not in a limitative sense.

### EXAMPLES

### Example 1—Synthesis of V052 Additive

A polyhydroxy surfactant for improved performance of electrophoretic systems (V052) is shown in Formula IV.

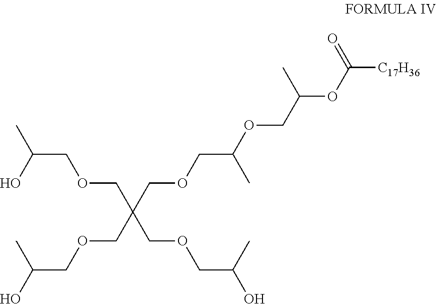

To synthesize V052, oxalyl chloride (28.0 mL, 1.04 eq.) was added dropwise over 1 h to a vigorously stirred suspension of stearic acid (89.0 g, 1 eq.) in DCM (300 mL) and DMF (6.0 mL) in a 1 L round bottom flask taking care not to let foaming (due to gas evolution) get out of control. Following the completion of addition, the brown reaction mixture was additionally stirred for 30 min, concentrated on a rotary evaporator and redissolved in DCM (200 mL). In a separate 2 L round bottom flask pentaerythritol propoxylate 5/4 PO/OH (200 g, 1.50 eq.) was dissolved in DCM (0.5 L). TEA (46.0 mL, 1.10 eq.) and DMAP (477 mg, 0.01 eq.) were added all-at-once. The stearyl chloride solution was transferred dropwise via a cannula to the resulting stirred solution over 3 h. After allowing the reaction mixture to stir for an additional 2 h, white precipitate (triethylamine hydrochloride) was filtered out and the filtrate was concentrated on a rotary evaporator. Purification by silica gel chromatography (hexanes→7:3 ethyl acetate:hexanes) afforded V052 (115 g, 53%) as a light yellow clear oil that was used directly for addition to electrophoretic particle systems, as described below. All reagents and solvents used in the synthesis were purchased from commercial sources and used without additional purification.

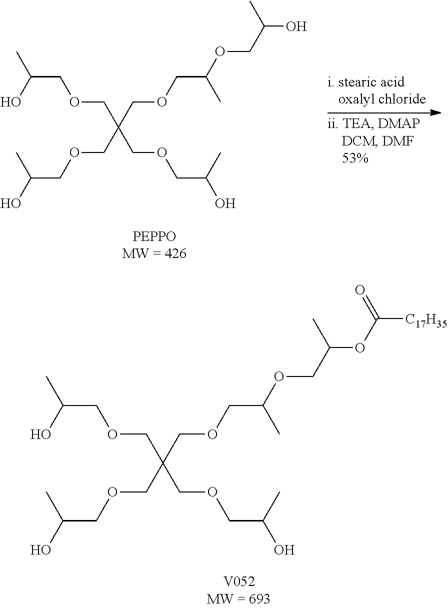

### Example 2—Comparison of Microcell Electrophoretic Laminates with Polyhydroxy Surfactant in Sealing Layer and in Electrophoretic Medium

Two poly(methyl methacrylate) microcell films were prepared as described in U.S. Pat. No. 6,930,818, the content of which is incorporated herein by reference in its entirety. Next, a three-electrophoretic-particle medium of the type described in U.S. Patent Publication No. 2014/0092465 was prepared. To a first sample of the electrophoretic medium, 2,5,8,11 tetramethyl 6 dodecyn-5,8 diol ethoxylate (DYNOL, Air Products) was added to achieve a ratio of 1:200 (wt/wt) surfactant to electrophoretic particle (SAMPLE A). A second sample had no DYNOL surfactant added (SAMPLE B).

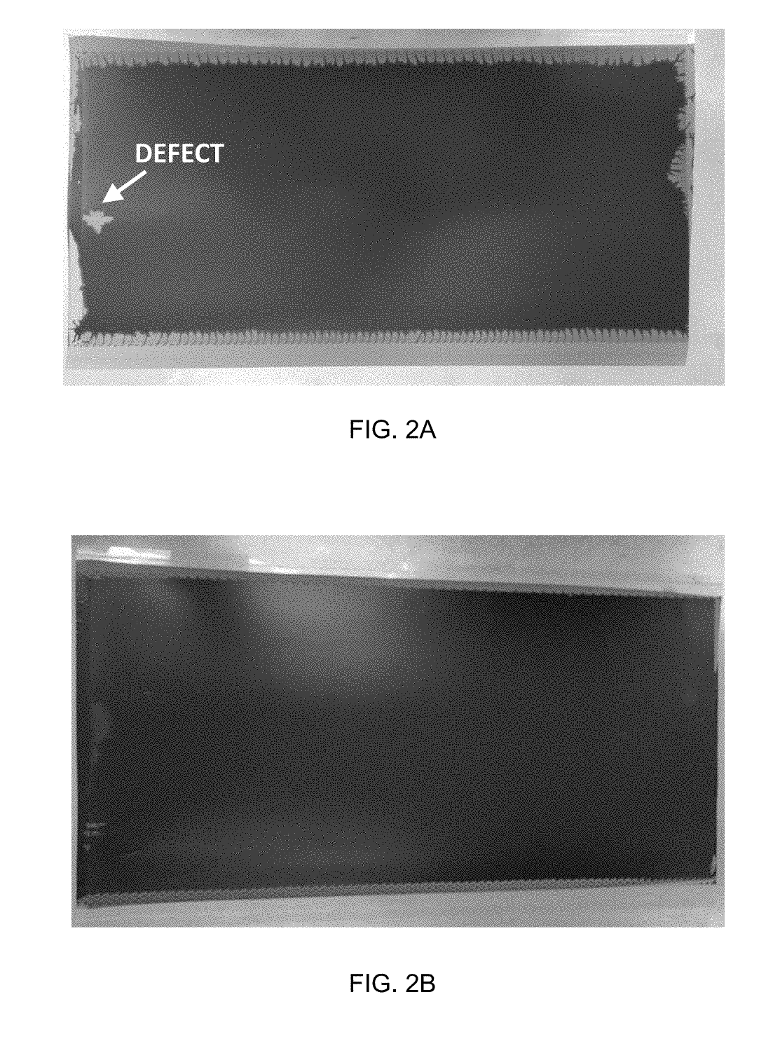

Two sealing compositions, comprising conductive fillers, were prepared as described in U.S. patent application Ser. No. 14/880,081, incorporated herein by reference in its entirety. To the second sealing composition, 2,5,8,11 tetramethyl 6 dodecyn-5,8 diol ethoxylate (DYNOL, Air Products) was added. The first microcell film was then filled with SAMPLE A of three-electrophoretic particle media, i.e., that contained 2,5,8,11 tetramethyl 6 dodecyn-5,8 diol ethoxylate. The filled microcell films were then sealed with the first sealing composition using a slot die coating process. The results of sealing Sample A are shown in FIG. 2A.

The second microcell film was filled with the second sample of three-electrophoretic particle media (SAMPLE B), i.e., which did not contain DYNOL surfactant. The microcell film sealed with SAMPLE B was then sealed with a second sealing layer comprising [1.5%?] 2,5,8,11 tetramethyl 6 dodecyn-5,8 diol ethoxylate. The results of sealing Sample B are shown in FIG. 2B.

Comparing FIGS. 2A and 2B, it is clear that the microcell film comprising the electrophoretic sample with DYNOL (FIG. 2A) exhibits a sealing shrinkage defect on the side edge of the sealing layer because the composition de-wet the film. In contrast, the microcell film sealed by the sealing comprising DYNOL (FIG. 2B) showed no sealing shrinkage defects. A filled microcell laminate with sealing shrinkage defects (like FIG. 2A) cannot be used for the production of electrophoretic displays, thus the laminate would be scrapped.

### Example 3—Comparison of Electrophoretic Performance with Sealing Layer Having Polyhydroxy Surfactant

As shown in Example 2, adding a surfactant, such as 2,5,8,11 tetramethyl 6 dodecyn-5,8 diol ethoxylate to an electrophoretic medium can cause the electrophoretic medium to dewet a microcell film, making the assembly unsuitable for use as an electrophoretic display. Nonetheless, it has been recognized that the overall performance of an electrophoretic display is typically improved with the inclusion of surfactants in the electrophoretic medium. See, e.g., U.S. Pat. No. 7,411,719, incorporated by reference herein. The surfactants increase the mobility of the charged electrophoretic particles in the electrophoretic fluid and discourage particle aggregation.

Surprisingly, it turns out that the benefits of including a surfactant in the electrophoretic medium can still be achieved by including the surfactant in only the sealing layer and not the electrophoretic medium. This technique allows an electrophoretic medium that is very low, or absent of, surfactants to be used when filling microcell films. The low surfactant electrophoretic medium wets the microcells well, thus producing consistent electrophoretic laminates. After the low-surfactant electrophoretic medium is sealed with a composition comprising a polyhydroxy surfactant, the surfactant migrates into the electrophoretic medium resulting in improved electrophoretic performance. An additional benefit is that the polyhydroxy surfactant in the sealing composition helps the sealing composition to wet the microcell film, and form a robust seal to microcell film to capture the electrophoretic medium therein.

To verify improved electrophoretic media performance using a sealing composition including a polyhydroxy surfactant, a series of microcell displays were constructed using a three-electrophoretic particle medium of the type described in U.S. Patent Publication No. 2014/0092465. The electrophoretic medium did not contain any 2,5,8,11 tetramethyl 6 dodecyn-5,8 diol ethoxylate (DYNOL).

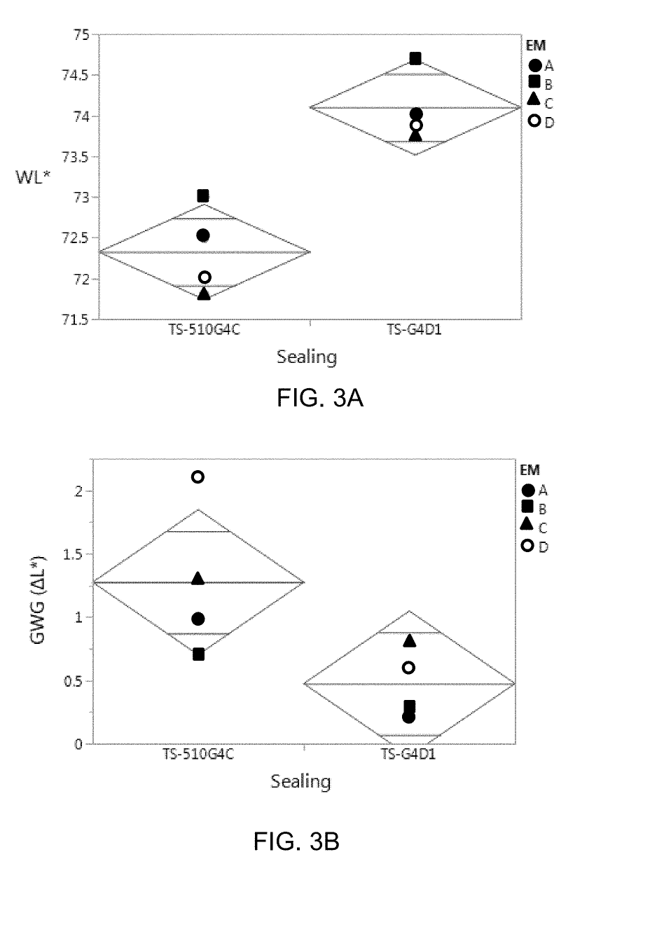

Four displays were sealed with a hydrophilic sealing composition without DYNOL (Series TS-510G4C). Four other displays were sealed with a conductive hydrophilic sealing composition with 1.7% DYNOL (Series TS-GD41). The displays were evaluated for relative reflectance and color in the light and dark states using an X-rite iOne spectrophotometer with D65 illumination (X-rite, Grand Rapids, Mich.). The data is reported using CIELAB color space algorithms. The level of ghosting was determined by driving the display between light and dark images and evaluating the amount of residual reflectance when going from light to dark images, and the amount of reduced reflectance when going from dark to light images. In practice, each display was driven between positive and negative checkerboard patterns while the change in L* was measured at several locations, thereby allowing for the collection of many relevant data points in a short amount of time. The averaged results of white state WL* and White state ghosting GWG(ΔL)* are shown in FIG. 3A and FIG. 3B. It is clear that the electrophoretic displays constructed with the sealing composition including DYNOL have superior performance. For example the white state was on average 2L* greater in the displays having the DYNOL in the sealing layer, while the white state ghosting was improved by over 50%.

It will be apparent to those skilled in the art that numerous changes and modifications can be made in the specific embodiments of the invention described above without departing from the scope of the invention. Accordingly, the whole of the foregoing description is to be interpreted in an illustrative and not in a limitative sense.

1. A sealing composition for an electrophoretic display comprising a light-transmissive electrode, an electrophoretic medium including charged particles, and a sealing layer comprising the sealing composition, the sealing composition comprising a polyhydroxy surfactant that is dispersible in the electrophoretic medium.

2. The sealing composition of claim 1, wherein the polyhydroxy surfactant is a polyhydroxy acetylene moiety.

3. The sealing composition of claim 2, wherein the polyhydroxy acetylene moiety comprises Formula I: 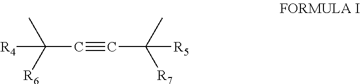
wherein R₄ and R₅ are independently H, or a C₁-C₃₆ branched or unbranched, saturated or unsaturated, alkyl, and R₆ and R₇ are independently —OH, —(OCH₂)ₘOH₅, —(OCH₂CH₂)ₙOH, or —(OCH₂CHCH₃)ₚOH, wherein m, n, and p are integers from 1 to 30.

4. The sealing composition of claim 3, wherein the polyhydroxy acetylene moiety is 2,4,7,9-tetramethyldecyn-4,7-diol; 1,4-dimethyl-1,4-bis(2-methylpropyl)-2-butyne-1,4-diyl ether; or 2,5,8,11 tetramethyl 6 dodecyn-5,8 diol ethoxylate.

5. The sealing composition of claim 2, wherein the polyhydroxy acetylene moiety comprises Formula II: 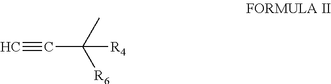
wherein R₄ is H, or a C₁-C₃₆ branched or unbranched, saturated or unsaturated, alkyl, and R₆ is —OH, —(OCH₂)ₘOH₅, —(OCH₂CH₂)ₙOH, or —(OCH₂CHCH₃)ₚOH, wherein m, n, and p are integers from 1 to 30.

6. The sealing composition of claim 5 wherein the polyhydroxy acetylene moiety is 3,5-dimethyl-1-hexyn-3-ol.

7. The sealing composition of claim 1, wherein the polyhydroxy surfactant is of Formula III: 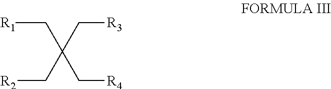
wherein R₁, R₂, R₃, and R₄ are independently selected from —OH, —(CH₂)ₘOH, —(OCH₂CH₂)ₙOH, —(OCH₂CHCH₃)_{q}OH, —OCOR₅, —(CH₂)ᵣOCOR₅, —(OCH₂CH₂)ₜOCOR₅, and —(OCH₂CHCH₃)ᵤOCOR₅, wherein each R₅ is independently a C₅-C₃₆ branched or unbranched alkane, fluoroalkane, or polyalkylsiloxane, and m, n, q, r, t, and u are independently integers from 1 to 30, and wherein at least one of R₁, R₂, R₃, or R₄ is —OCOR₅, —(CH₂)ᵣOCOR₅, —(OCH₂CH₂)ₜOCOR₅, or —(OCH₂CHCH₃)ᵤOCOR₅.

8. The sealing composition of claim 7, wherein R₁, R₂, and R₃ are —OH, R₄ is —OCOR₅, and R₅ is a C₅-C₃₆ branched or unbranched alkane, fluoroalkane, or polyalkylsiloxane.

9. The sealing composition of claim 1, wherein the sealing composition comprises acrylics, styrene-butadiene copolymers, styrene-butadiene-styrene block copolymers, styrene-isoprene-styrene block copolymers, polyvinylbutyral, cellulose acetate butyrate, polyvinylpyrrolidone, polyurethanes, polyamides, ethylene-vinylacetate copolymers, epoxides, multifunctional acrylates, vinyls, vinylethers, polyvinyl alcohol; polyethylene glycol, polypropylene glycol; polysaccharides; gelatin polyacrylamide; or polymethacrylamide.

10. The sealing composition of claim 1, wherein the sealing composition comprises 0.01% to 7% by weight of carbon nanotubes and 0.1% to 20% by weight of graphite.

11. The sealing composition of claim 1, wherein the electrophoretic medium does not comprise a polyhydroxy surfactant prior to being incorporated into the electrophoretic display.

12. The sealing composition of claim 1, wherein the sealing composition comprises a polyhydroxy surfactant of Formula IV: 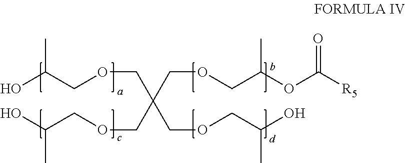
wherein a, b, c, and d are independently integers from 0-20, wherein at least one of a, b, c, and d is 1 or greater, and wherein R₅ is a C₅-C₃₆ branched or unbranched alkane, fluoroalkane, or polyalkylsiloxane.

13. The sealing composition of claim 12, wherein R₅ is a C₁₀-C₂₀ unbranched alkane, fluoroalkane, or polyalkylsiloxane.

14. The sealing composition of claim 1, wherein the sealing composition comprises a polyhydroxy surfactant of Formula V: 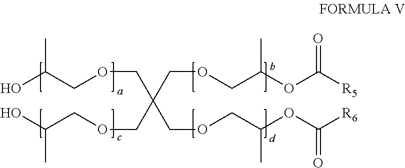
wherein a, b, c, and d are independently integers from 0-20, wherein at least one of a, b, c, and d is 1 or greater, and wherein R₅ is a C₅-C₃₆ branched or unbranched alkane, fluoroalkane, or polyalkylsiloxane.

15. The sealing composition of claim 14, wherein R₅ or R₆ is a C₁₀-C₂₀ unbranched alkane of fluoroalkane.

16. The sealing composition of claim 1, further comprising conductive fillers.

17. The sealing composition of claim 16, wherein the conductive fillers comprise carbon black, graphite, graphene, metal filaments, metal particles, or carbon nanotubes.

18. The sealing composition of claim 16, wherein the electrophoretic medium is encapsulated.

19. The sealing composition of any of claim 1, wherein the electrophoretic medium is encapsulated.

20. The sealing composition of claim 19, wherein the electrophoretic medium is encapsulated in a microcell or a protein coacervate.

21. The sealing composition of claim 20, wherein the microcells are formed from a polymer.

22. The sealing composition of claim 21, wherein the microcells are formed from a thermoplastic or a composition comprising a difunctional UV curable component, a photoinitiator, and a release agent.
